(19) United States
(12) Patent Application Publication
(10) Pub. No.: US 2009/0225355 A1
(43) Pub. Date: Sep. 10, 2009

(54) Printing apparatus and printing control method

(75) Inventors: Minako Kazume, Kanagawa (JP); Hiroshi Gotoh, Tokyo (JP); Hozumi Yonezawa, Tokyo (JP); Takahiro Hirakawa, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/379,854

(22) Filed: Mar. 3, 2009

(30) Foreign Application Priority Data
Mar. 7, 2008 (JP) 2008-057683

(51) Int. Cl. G06F 3/12

(52) U.S. Cl. 358/1.15

(57) ABSTRACT

A first transmitting unit transmits print hold information to other printing apparatus connected on a downstream side in a data transmitting direction. A second transmitting unit transmits printing data from a host apparatus to the other printing apparatus. A third transmitting unit transmits page deletion information to the other printing apparatus every time a page is printed. When a printing condition cannot be satisfied, a fourth transmitting unit transmits print-disable information to the other printing apparatus, and releases a hold of the printing process in the other printing apparatus according to the print-disable information.

### CROSS-REFERENCE TO RELATED APPLICATIONS

The present application claims priority to and incorporates by reference the entire contents of Japanese priority document 2008-057683 filed in Japan on Mar. 7, 2008.

### BACKGROUND OF THE INVENTION

1. Field of the Invention

The present invention relates to a printing apparatus and a printing control method.

2. Description of the Related Art

An Internet printing system that performs printing via the Internet network has been recently developed (Japanese Patent Application Laid-open No. 2003-271347).

Recently, as shown in FIG. 20, an extranet that interconnects intranets 200 and 300 in companies or offices via an Internet network 400 has been used. According to a network environment shown in FIG. 20, a printing process can be performed from a host computer such as a server on the intranet 200 on one side to a printer on the intranet 300 on the other side.

However, in the Internet printing system disclosed in Japanese Patent Application Laid-open No. 2003-271347 or the network environment shown in FIG. 20, even if the printing is held due to a print-disabled state (paper out, paper jam, toner out, or other failures) of the printer requiring an operator's operation in the middle of printing, the host computer cannot check the status of the printer, and the printer can be left in a printing hold state.

In addition, in the network environment, because there is no means for sending information such as an output destination/output number of pages on the printer side to the server, after the server executes printing, it cannot check the status of the printer.

### SUMMARY OF THE INVENTION

It is an object of the present invention to at least partially solve the problems in the conventional technology.

According to one aspect of the present invention, there is provided a printing apparatus including a connecting unit that makes a network connection to other printing apparatus that performs a printing process of printing data transmitted from a host apparatus on a printing medium on a downstream side in a data transmission direction; a first transmitting unit that transmits print hold information for holding the printing process to the other printing apparatus; a second transmitting unit that transmits the printing data to the other printing apparatus; a third transmitting unit that transmits page deletion information for deleting data corresponding to a printed page to the other printing apparatus every time a page is printed on the printing medium; and a fourth transmitting unit that transmits, when a function of the printing apparatus cannot satisfy a condition specified by the host apparatus at a time of printing, print-disable information to the other printing apparatus, and releases a hold of the printing process in the other printing apparatus according to the print-disable information.

Furthermore, according to another aspect of the present invention, there is provided a printing control method for a printing apparatus that performs a printing process of printing data transmitted from a host apparatus on a printing medium. The printing control method includes making a network connection to other printing apparatus on a downstream side in a data transmission direction; first transmitting including transmitting print hold information for holding the printing process to the other printing apparatus; second transmitting including transmitting the printing data to the other printing apparatus; third transmitting including transmitting page deletion information for deleting data corresponding to a printed page to the other printing apparatus every time a page is printed on the printing medium; and fourth transmitting including transmitting, when a function of the printing apparatus cannot satisfy a condition specified by the host apparatus at a time of printing, print-disable information to the other printing apparatus, and releasing a hold of the printing process in the other printing apparatus according to the print-disable information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a system configuration example of a network print system according to an embodiment of the present invention;

FIG. 2 is a schematic diagram of a system configuration example of the network print system;

FIG. 3 is a block diagram of one example of a configuration of a print server;

FIG. 4 is a block diagram of one example of a configuration of a printer;

FIG. 5 is a schematic diagram of a functional configuration of a printer substituting process;

FIG. 6 is a sequence diagram of a network printing process procedure including the printer substituting process;

FIG. 7 is a schematic diagram of a table of printer information;

FIG. 8 is a schematic diagram of updating of the table;

FIG. 9 is a schematic diagram of a method of sequentially merging and transmitting response information;

FIG. 10 is a schematic diagram of a functional configuration relating to a job synchronizing process in the printer substituting process;

FIG. 11 is a sequence diagram of a printing process procedure at a normal time;

FIG. 12 is a schematic diagram of a merging process of response information;

FIG. 13 is a schematic diagram of a page information table;

FIG. 14 is a schematic diagram of a failure information table;

FIG. 15 is a sequence diagram of a printing process procedure when a print-disabled state occurs during a printing process;

FIG. 16 is a schematic diagram of an alternative printing function;

FIG. 17 is a schematic diagram of one example of alternative printing;

FIG. 18 is a schematic diagram of a printing process of a printing result report;

FIG. 19 is one example of the printing result report; and

FIG. 20 is a schematic diagram of a system configuration example in a conventional network environment.

### DETAILED DESCRIPTION OF THE PREFERRED EMBODIMENTS

Exemplary embodiments of the present invention will be explained below in detail with reference to accompanying drawings. In the embodiments, a laser printer or a multi-function peripheral (MFP) is applied as a printing apparatus.

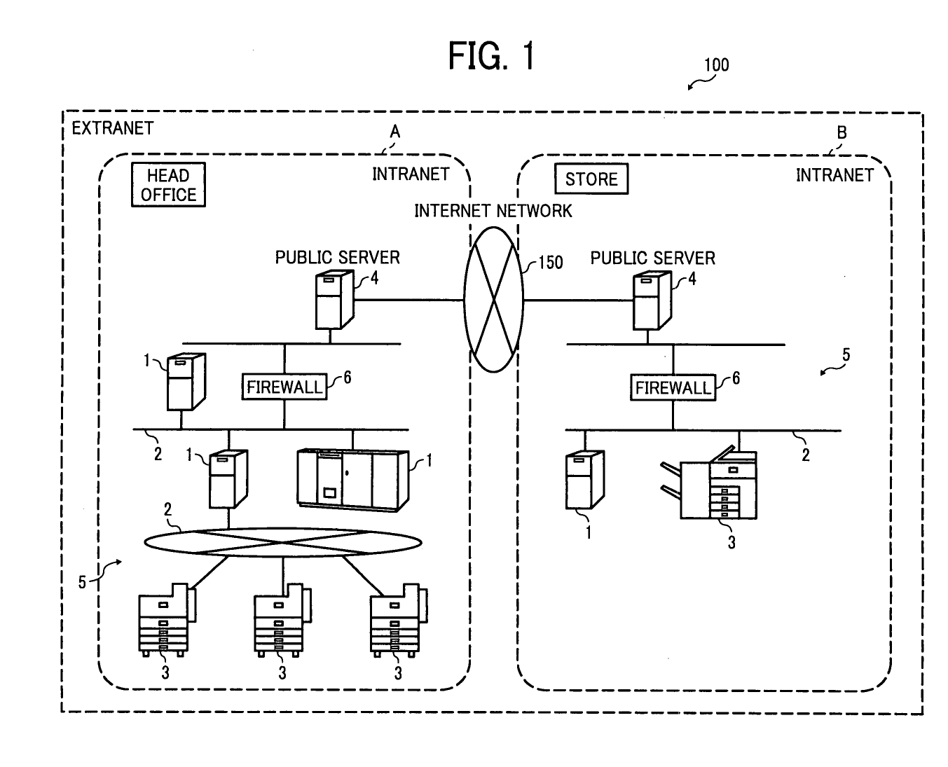

FIG. 1 is a schematic diagram of a system configuration example of a network print system 100 according to an embodiment of the present invention. As shown in FIG. 1, for the network print system 100 according to the present embodiment, a network environment is assumed in which an intranet A and an intranet B in plural companies or offices, which are corporate networks based on the Internet technique, are interconnected with each other via an Internet network 150.

As shown in FIG. 1, for example, as the intranet A in a head office of a convenience store chain, there is assumed a server client system in which a plurality of clients 3 such as a computer and a printer is connected to various server computers (hereinafter, “server”) 1 via a network 2 such as a local area network (LAN). In the intranet A, a firewall 6 is provided at a boundary between the Internet network 150 and a corporate network 5 excluding a public server 4 such as World Wide Web (WWW). The firewall 6 monitors a packet that comes in and out between the corporate network 5 and the Internet network 150, to allow the passage of the packet or discard the packet according to a predetermined rule, thereby ensuring security in the corporate network 5.

On the other hand, for example, as the intranet B in a franchise store, there is assumed a server client system in which the clients 3 such as the computer and the printer are connected to the various servers 1 via the network 2 such as the LAN. Also in the intranet B, the firewall 6 is provided at the boundary between the Internet network 150 and the corporate network 5 excluding the public server 4.

The network connection between the intranets A and B is not limited to the Internet network 150, and the intranets A and B can be connected by using a dedicated communication line.

The network 2 is not limited for wire communication, and can be for wireless communication (infrared, radiowave, or the like). The network 2 can use optical fibers as well.

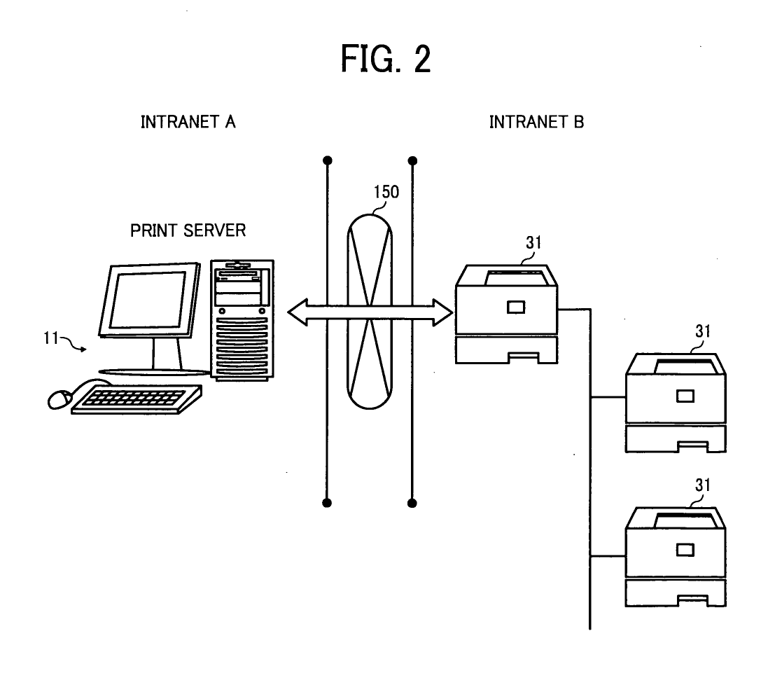

As shown in FIG. 2, the network print system 100 can directly perform the printing process, for example, for a promotional material or the like from a print server 11, which is one of the servers 1 provided in the intranet A in, for example, the head office of the convenience store with respect to a printer 31, which is one of the clients 3 provided in the intranet B of the franchise store. As shown in FIG. 2, a plurality of printers 31 having the same function are provided in the intranet B.

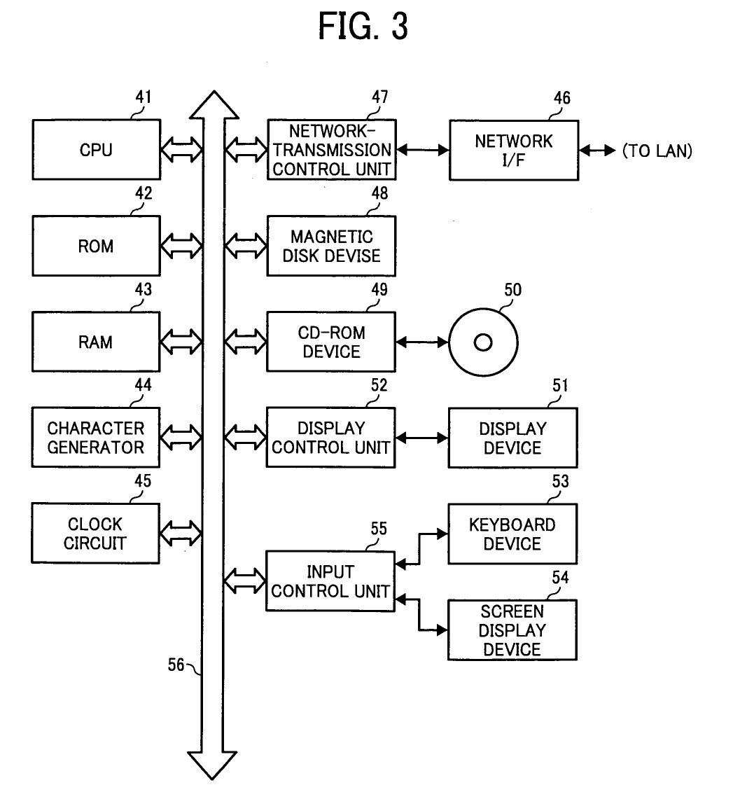

The print server 11 (the server 1) provided in the intranet A is explained next. FIG. 3 is a block diagram of one example of a configuration of the print server 11. As shown in FIG. 3, the print server 11 includes a central processing unit (CPU) 41 that performs operation control of the print server 11. A read only memory (ROM) 42 for storing a program executed by the CPU 41 at the time of start-up or required data, and a random access memory (RAM) 43 for configuring a work area and the like of the CPU 41 are connected to the CPU 41 via an internal bus 56.

Further, a character generator 44, a clock circuit 45, a network-transmission control unit 47, a magnetic disk device 48, a compact disk read only memory (CD-ROM) device 49, a display control unit 52, and an input control unit 55 are connected to the CPU 41 via the internal bus 56, and data is transferred between the respective components mainly via the internal bus 56.

The character generator 44 generates display data in graphic characters. The clock circuit 45 outputs information of current date and time.

A network interface (I/F) circuit 46 connects the print server 11 to the network 2, which is the LAN, and the network-transmission control unit 47 performs a communication control process with respect to various predetermined protocol suites for transferring various pieces of data with other servers 1 and the clients 3 via the network 2. For example, the network I/F circuit 46 connects the printer 31, which is one of the clients 3 provided in another intranet (the intranet B) via the network 2 and the Internet network 150, and performs operations such as transmitting print data or the like to the printer 31, or receiving printing status or the like from the printer 31.

The magnetic disk device 48 stores an operating system (OS) and various data such as various application programs running on the OS, work data, file data, and image information data. According to the present embodiment, a print data transmission program and the like are stored as the application program. The CD-ROM device 49 reads data (various types of data such as various application programs, work data, file data, and image information data) stored in a CD-ROM 50, which is a replaceable recording medium.

In the print server 11, when a user turns on power, the CPU 41 starts up a program referred to as a loader in the ROM 42, and reads the OS from the magnetic disk device 48 into the RAM 43 to start up the OS. The OS starts up the application program, reads information, or stores the information in response to user's operation. The recording medium is not limited to the CD-ROM 50, and can be a computer readable recording medium such as a flexible disk (FD), a CD-recordable (CD-R), a CD-rewritable (CD-RW), a digital versatile disk (DVD), and a semiconductor memory. In this case, the CD-ROM device 49 can be of course changed to the one capable of reading the data on the recording medium. Further, the application program is not limited to the one operating on the predetermined OS, and can be the one that allows the OS to take over execution of a part of various types of processing described later, or the one included as a part of predetermined application software or a group of program files constituting the OS.

Generally, the application program installed in the magnetic disk device 48 of the print server 11 is recorded on the recording medium such as the CD-ROM 50, and the application program recorded on the recording medium is installed in the magnetic disk device 48. Accordingly, a portable recording medium such as the CD-ROM 50 can be the recording medium that stores the application program. Further, the application program can be taken in from outside via, for example, the network I/F circuit 46 and installed in the magnetic disk device 48.

A display device 51 such as a cathode ray tube (CRT) and a liquid crystal display (LCD) displays a screen for operating the print server 11, and the display control unit 52 controls a display content of the display device 51.

A keyboard device 53 issues various instructions to the print server 11 by various key operations, and a screen display device 54 is for performing an operation such as indicating an arbitrary point on the display device 51 (for example, a pointing device such as a mouse), and the input control unit 55 obtains input information of the keyboard device 53 and the screen display device 54.

An appropriate application program is started up by the print server 11, and printed document information is generated by the application program and stored in the magnetic disk device 48, or printed document information stored on the CD-ROM 50 is read by the CD-ROM device 49 and taken into the print server 11, or the printed document information is reconstructed from information received by an e-mail via the network 2 and the Internet network 150 and taken into the print server 11, and stored in the print server 11.

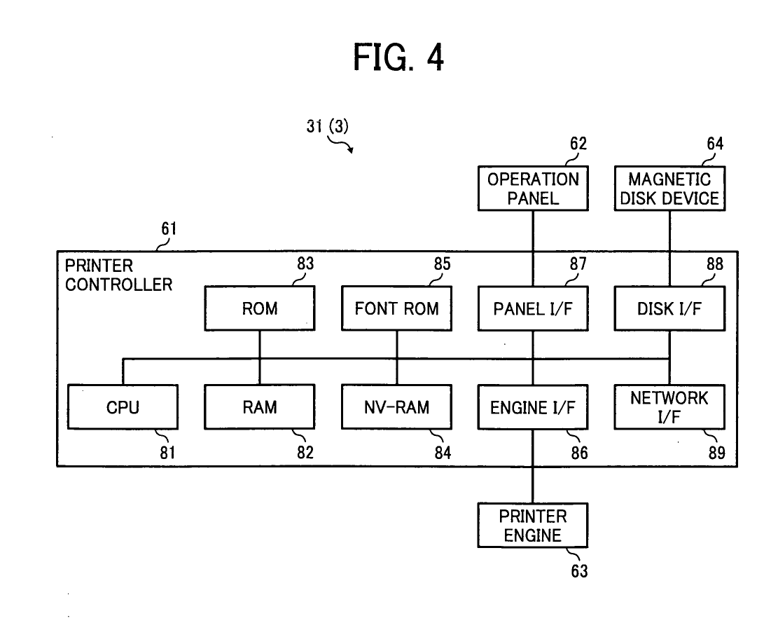

The printer 31 (the client 3), which is the printing apparatus provided in the intranet B, is explained next. FIG. 4 is a block diagram of one example of a configuration of the printer 31. As shown in FIG. 4, the printer 31 includes a printer controller (a motherboard) 61 that performs various types of control processing such as control processing of respective units in the printer 31 and image forming processing. An operation panel 62, a printer engine 63, and a magnetic disk device 64 are connected to the printer controller 61.

The printer controller 61 is a general term of a control mechanism that converts print data from the various servers 1 in the respective intranets A and B (for example, the print server 11 in the intranet A) to drawing data according to a control mode set at that time and a control code from the various servers 1 in the respective intranets A and B (for example, the print server 11 in the intranet A), and outputs the drawing data to the printer engine 63, and is configured by a module described below. That is, the printer controller 61 includes a CPU 81 as a control subject, a RAM 82, a ROM 83 for storing various pieces of information unique to the printer 31, a non-volatile RAM (NV-RAM) 84 as a nonvolatile memory capable of holding data regardless of power ON/OFF, a font ROM 85 as a memory for holding several types of typefaces used at the time of printing, an engine I/F 86, a panel I/F 87 that connects the operation panel 62, a disk I/F 88 that connects the magnetic disk device 64, and a network I/F 89.

The RAM 82 is used as a work area of the CPU 81, a buffer for receiving data from various servers 1 in the respective intranets A and B, and an image expansion area after processing.

The engine I/F 86 transfers a control signal from the printer controller 61 to the printer engine 63 and a status signal from the printer engine 63 to the printer controller 61.

The network I/F 89 transfers a control signal and data from the various servers 1 in the respective intranets A and B (for example, the print server 11) to the printer 31 and a status signal from the printer 31 via the network 2.

The operation panel 62 is a switch capable of changing status display, mode, and printing condition of the printer 31.

The printer engine 63 forms an image according to an electrophotographic process and records and outputs the image on recording paper. More specifically, the printer engine 63 electrostatically forms an image on a photoconductor based on the drawing data and control information from the printer controller 61, and feeds transfer paper from a paper feeder to form an image.

The magnetic disk device 64 stores various types of printed document information, and stores appropriate information files other than the printed document information. In addition, the magnetic disk device 64 stores the OS and various application programs running on the OS. According to the present embodiment, a printing program and the like are stored as the application program.

The printer 31 with such a configuration reads the OS from the magnetic disk device 64 to the RAM 82 when the user turns on the power, as in the server 1, to start up the OS. The OS started up in this manner starts up the application program, reads information, or stores the information in response to the user's operation. The application program is not limited to the one operating on the predetermined OS, and can be the one that allows the OS to take over execution of a part of various types of processing described later, or the one included as a part of the predetermined application program or a group of program files constituting the OS.

Generally, the application program installed in the magnetic disk device 64 of the printer 31 is recorded on the recording medium such as the CD-ROM (not shown), and the application program recorded on the recording medium is installed in the magnetic disk device 64. Accordingly, the portable recording medium such as the CD-ROM can be the recording medium that stores the application program. Further, the application program can be taken in from outside via, for example, the network I/F 89 and installed in the magnetic disk device 64.

The printer 31 according to the present embodiment includes the magnetic disk device 64. However, the printer 31 is not limited thereto, and the application program and the OS can be stored on a computer readable recording medium such as a semiconductor memory.

Among various types of arithmetic processing performed by the CPU 41 in the print server 11 and the CPU 81 in the printer 31, a printer substituting process, which is a characteristic process of the network print system 100 according to the present embodiment, is explained next.

In the network print system 100, when print data is input from the print server 11 as a host apparatus of the intranet A to the printer 31 in the intranet B via the Internet network 150, drawing data is generated for the input print data on the printer 31 in the intranet B based on the control information of the printer controller 61, the generated drawing data is transmitted from the printer controller 61 to the printer engine 63, and a print start command is issued to start printing. In the printer 31 performing the printing process in the intranet B, a print-disabled state (paper out, paper jam, toner out, or other failures) requiring an operator's operation may occur even in the middle of printing. In the network print system 100, therefore, when the print-disabled state requiring the operator's operation occurs in the printer 31, which is performing the printing process, the printer substituting process is performed such that an object to be printed is switched to another printer 31, thereby enabling to continue printing, so that the print-disabled state does not occur in the intranet B.

The print server 11 stores the print data transmission program in the magnetic disk device 48 as the application program. That is, in the print server 11, when the print data transmission program operating on the OS is started up, the CPU 41 controls respective units according to the print data transmission program, to perform a print data transmission process, which is a part of the printer substituting process.

The printer 31 stores the printing program in the magnetic disk device 64 as the application program. That is, in the printer 31, when the printing program operating on the OS is started up, the CPU 81 controls respective units according to the printing program, to perform the printing process, which is a part of the printer substituting process.

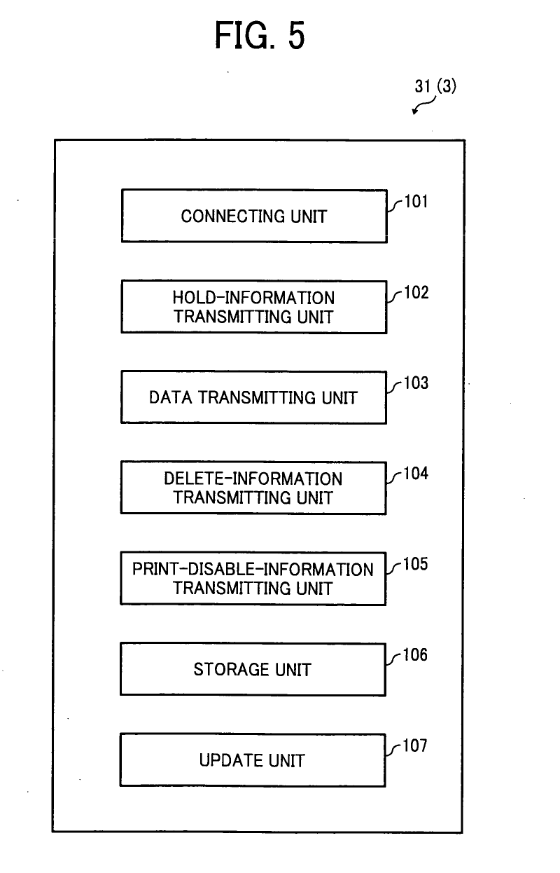

FIG. 5 is a schematic diagram of a functional configuration of the printer substituting process of the printer 31. As shown in FIG. 5, the printer 31 includes a connecting unit 101 that connects to another printer 31 via a network on a downstream side in a data transmission direction, a hold-information transmitting unit 102 that transmits print hold information for holding the printing process to the other printer 31 located on the downstream side, a data transmitting unit 103 that transmits the transmitted data to the other printer 31 located on the downstream side, a delete-information transmitting unit 104 that transmits page delete information to the other printer 31 located on the downstream side, every time one page is printed on the printing medium, for deleting data corresponding to a printed page stored by the other printer 31 according to the page delete information, and a print-disable-information transmitting unit 105 that transmits print-disable information indicating that a condition specified by the print server 11 at the time of printing does not match a function of the printer 31 to the other printer 31 located on the downstream side, and releases the hold of the printing process in the other printer 31 according to the print-disable information. As shown in FIG. 5, the printer 31 further includes a storage unit 106 that stores a function specifiable at the time of printing, and an update unit 107 that updates the function stored in the storage unit 106.

Main processes of the printer substituting process are specifically explained for each scene.

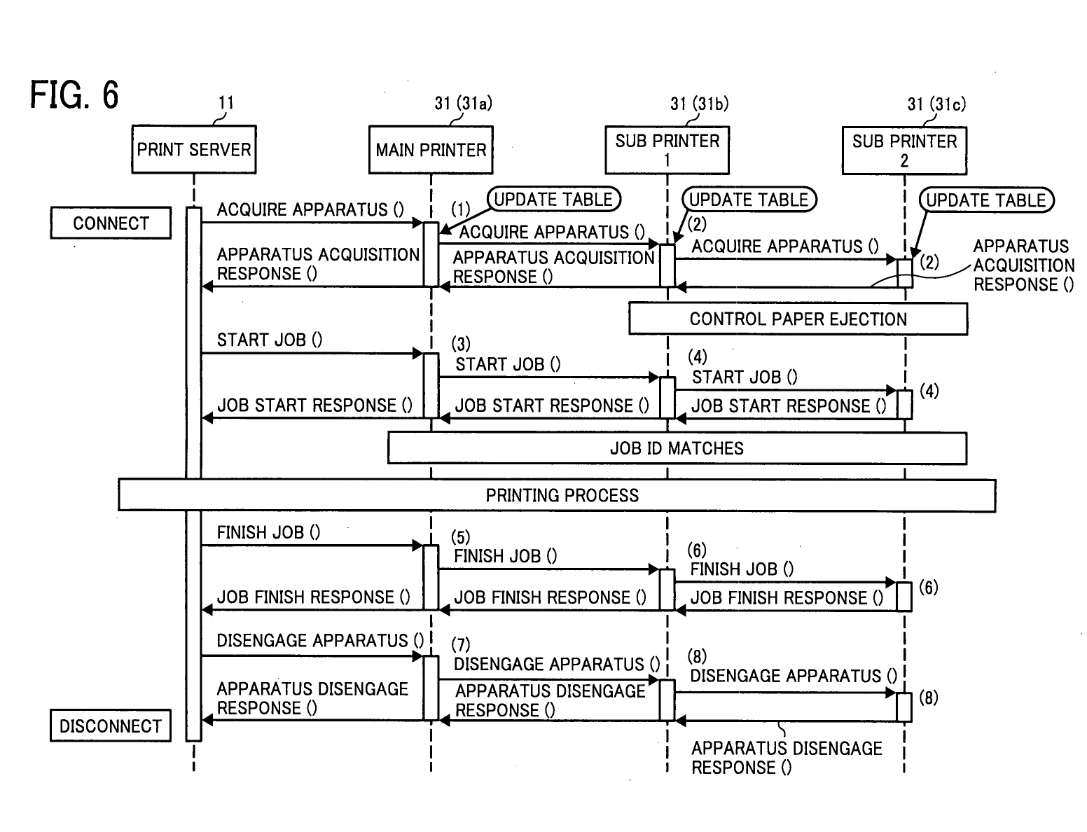

FIG. 6 is a sequence diagram of a network printing process procedure including the printer substituting process. In FIG. 6, as the intranet B, there is assumed a system in which three printers, that is, a printer 31a as a “main printer”, a printer 31b as a “sub printer 1”, and a printer 31c as a “sub printer 2” are connected via the network by the connecting unit 101, respectively.

The “main printer” is uniquely determined by the host apparatus. However, the “sub printer 1” and the “sub printer 2” can be determined fixedly or the sequence thereof can be changed for each process. For example, the sequence of the “sub printer 1” and the “sub printer 2” can be realized by storing an IP address of the printer, to which the data is transmitted next, in the storage unit (the ROM 83, the NV-RAM 84, or the magnetic disk device 64) of the printer, and referring to the stored IP address at the time of data transfer.

An apparatus acquiring process is performed first in the network printing process.

(1) Upon reception of an “Acquire apparatus” command from the print server 11, the main printer performs a printer occupying process and transmits the “Acquire apparatus” command to the sub printer (the sub printer 1 in FIG. 6). At this time, the hold-information transmitting unit 102 in the main printer specifies a hold of a paper ejection as information. The information is the print hold information for holding the printing process.

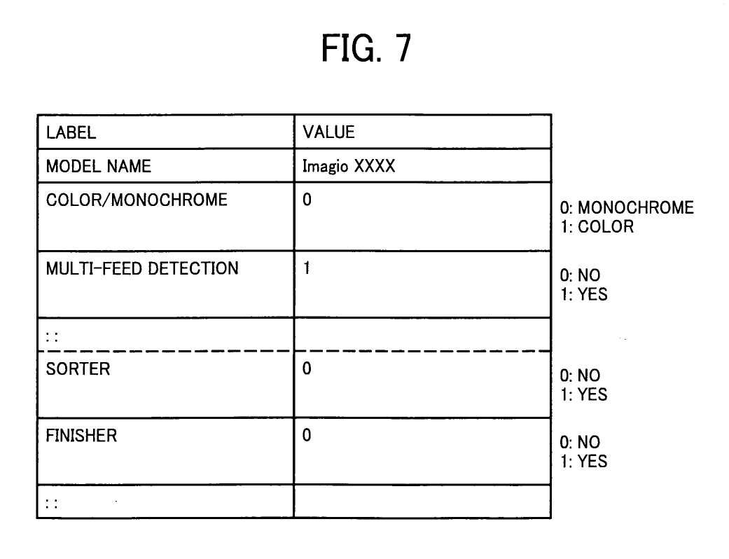

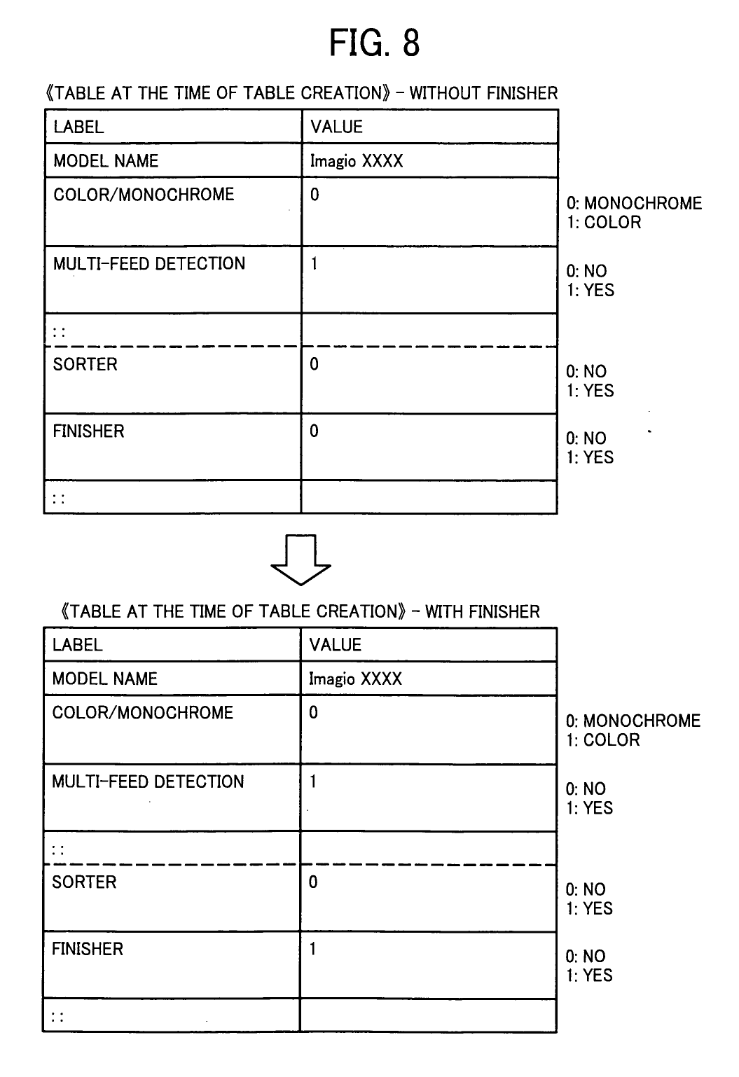

In addition, the storage unit 106 in the main printer holds the function specifiable at the time of printing as a table of printer information in the NV-RAM 84, and the update unit 107 in the main printer updates the table of the printer information held in the NV-RAM 84. FIG. 7 depicts the table. As shown in FIG. 7, the table holds information unique to each model, which is held in the ROM 83 and cannot be changed (color/monochrome, multi feed detection, and the like), and information held in the NV-RAM 84 and changeable for each model (information of a finisher or the like optionally incorporated). Such a table is generally created at the time of startup. In the present embodiment, however, the latest table is created by update, every time the “Acquire apparatus” command is received from the print server 11. Therefore, when the finisher is incorporated after startup and before reception of the “Acquire apparatus” command, the table is updated as shown in FIG. 8.

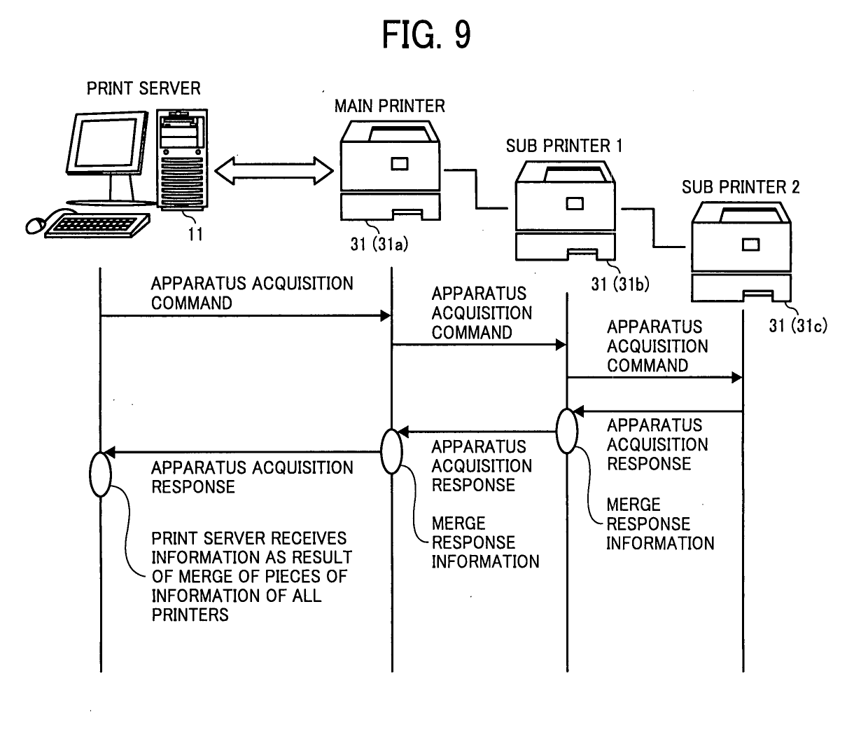

(2) The sub printer (the sub printer 1 in FIG. 6) performs the printer occupying process. Further, because a hold of paper ejection is specified in the information, the sub printer holds the paper ejection from the printer. In addition, the update unit 107 in the main printer updates the table of the printer information held in the NV-RAM 84. When there is a lower-level sub printer (on the downstream side in the data transmission direction) (the sub printer 2 in FIG. 6), the sub printer transmits the “Acquire apparatus” command received from an upper-level printer (an upstream side in the data transmission direction) to the lower-level sub printer. When there is no lower-level sub printer, the sub printer transmits an “Apparatus acquisition response” command to an upper-level printer. Further, the lower-level printer transmits the “Apparatus acquisition response” command to the upper-level printer. The apparatus acquisition response includes an IP address of the printer, and as shown in FIG. 9, the upper-level printer sequentially merges the response information (the IP address of the printer) from the lower-level printers and transmits the merged information. The main printer waits for the response from the sub printer and transmits the “Apparatus acquisition response” command to the print server 11.

Accordingly, the print server 11 receives the information as a result of merge of pieces of information of all printers.

An information transmission from the printer to the print server 11 is performed via the Internet network 150 and the firewall 6. Therefore, the passage thereof is permitted by ruling or the information is attached to an e-mail and transmitted. The same applies to information transmission from the printer to the print server 11 described below.

The print server 11 manages the printer information obtained by merging the pieces of information of respective sub printers and the main printer as a log.

(3) Upon reception of a “Start JOB” command from the print server 11, the main printer performs a “JOB start” process, and transmits the “Start JOB” command to the sub printer (the sub printer 1 in FIG. 6). At this time, the main printer adds an obtained JOB ID to the information.

(4) The sub printer (the sub printer 1 in FIG. 6) performs a JOB start process, but does not create the JOB ID. The sub printer achieves synchronization of job management between the printers by using the JOB ID notified from the main printer. When there is a lower-level sub printer (the sub printer 2 in FIG. 6), the sub printer transmits the “Start JOB” command received from an upper-level printer to the lower-level sub printer. When there is no lower-level sub printer, the sub printer transmits a “Job start response” command to an upper-level printer. Further, the lower-level printer transmits the “Job start response” command to the upper-level printer. The main printer waits for the response from the sub printer, and transmits the “Job start response” command to the print server 11.

Upon completion of the apparatus acquiring process in the network printing process, the printing process is performed.

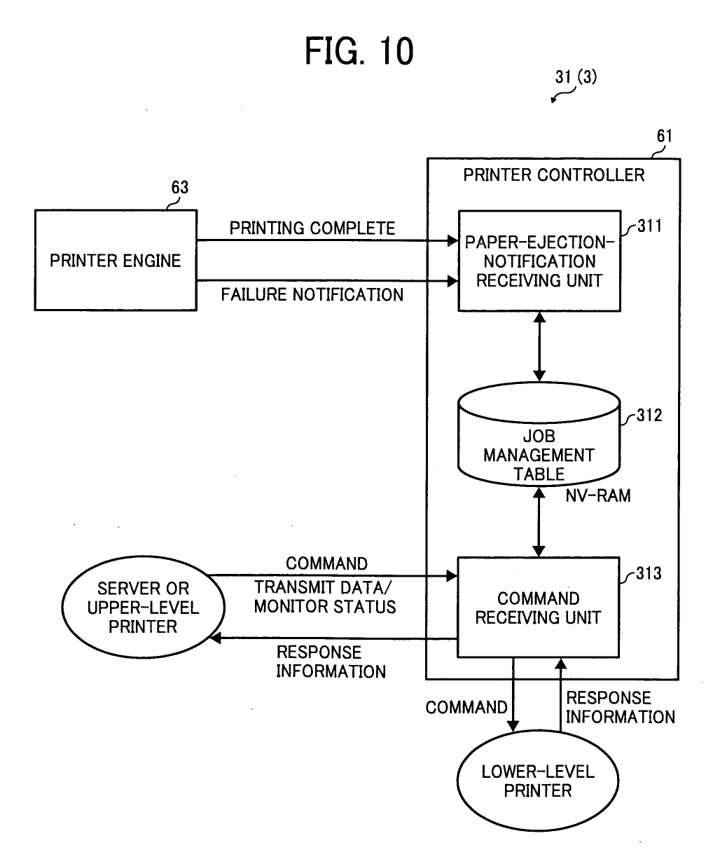

FIG. 10 is a schematic diagram of a functional configuration relating to a job synchronizing process in the printer substituting process of the printer 31. As shown in FIG. 10, the printer 31 includes a paper-ejection-notification receiving unit 311, a job management table 312 formed in the NV-RAM 84, and a command receiving unit 313, as the functional configuration relating to the job synchronizing process.

The paper-ejection-notification receiving unit 311 receives a printing completion notification from the printer engine 63. The paper-ejection-notification receiving unit 311 then reads the job management table 312, counts up the number of printed pages for each JOB ID, and stores the number of printed pages in the job management table 312. In addition, upon reception of a failure notification from the printer engine 63, the paper-ejection-notification receiving unit 311 stores an error code relating to the failure notification in the job management table 312.

The command receiving unit 313 receives a command (Transmit data/Monitor status) transmitted from the print server 11 (the server 1) or the upper-level printer 31 located on the upstream side in the data transmission direction, and transmits the received command to the lower-level printer (sub printer) 31 located on the downstream side in the data transmission direction. Further, upon reception of the response information corresponding to the Monitor status command from the lower-level printer (sub printer) 31, the command receiving unit 313 reads the job management table 312 to merge page information (including the number of printed pages) included in the response information. When the error code or failure information is included in the response information corresponding to the Monitor status command received from the lower-level printer (sub printer) 31, the command receiving unit 313 merges the failure information. The command receiving unit 313 returns the response information in the job management table 312 to the print server 11 (the server 1) or the upper-level printer 31.

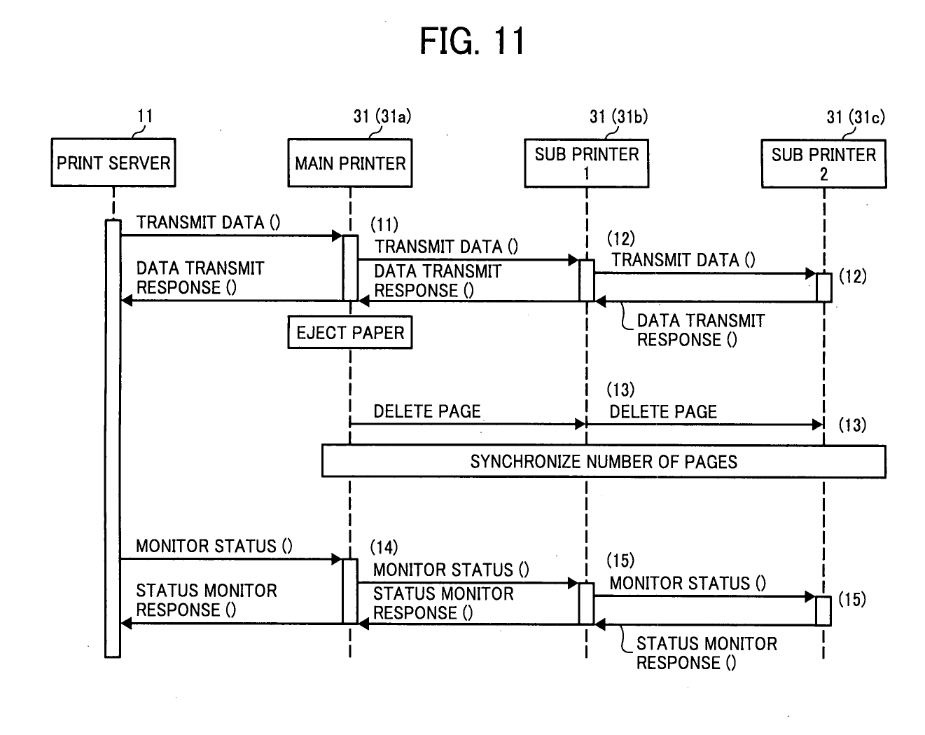

In such a functional configuration, a printing process procedure at a normal time is explained with reference to a sequence diagram shown in FIG. 11.

(11) Upon reception of the “Transmit data” command from the print server 11, the data transmitting unit 103 in the main printer transmits the “Transmit data” command to the sub printer (the sub printer 1 in FIG. 6).

(12) When there is a lower-level sub printer (the sub printer 2 in FIG. 6), the data transmitting unit 103 in the sub printer (the sub printer 1 in FIG. 6) transmits the “Transmit data” command received from the upper-level printer to the lower-level sub printer. When there is no lower-level sub printer, the sub printer transmits a “Data transmit response” command to the upper-level printer. The lower-level sub printer then performs the printing process. The main printer waits for the response from the sub printer, transmits the “Data transmit response” command to the print server 11, and performs the printing process.

(13) The delete-information transmitting unit 104 in the main printer transmits a “Delete page” command to the sub printer every time paper is ejected. The delete-information transmitting unit 104 in the sub printer receives the “Delete page” command, and when there is a lower-level sub printer, transmits the “Delete page” command received from the upper-level printer thereto. The sub printer having received the “Delete page” command achieves synchronization of the number of printed pages, and deletes the printed pages.

(14) Upon reception of the “Monitor status” command from the print server 11, the main printer transmits the “Monitor status” command to the sub printer (the sub printer 1 in FIG. 6).

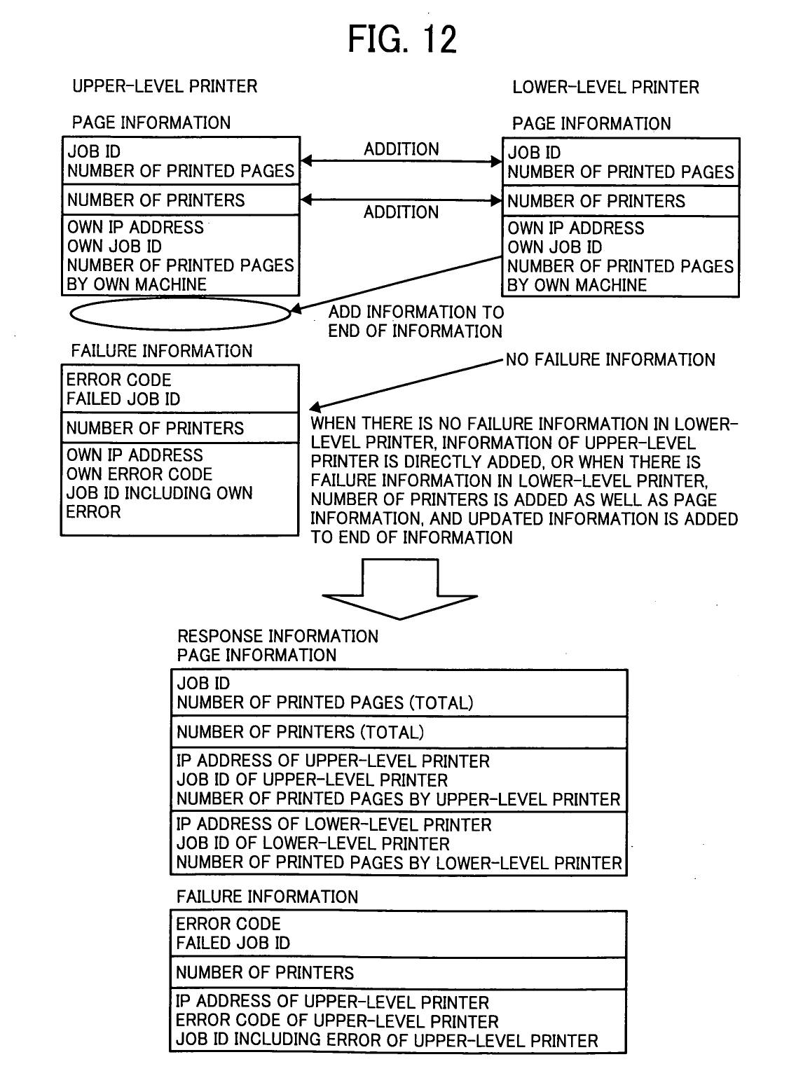

(15) When there is a lower-level sub printer (the sub printer 2 in FIG. 6), the sub printer (the sub printer 1 in FIG. 6) transmits the “Monitor status” command received from the upper-level main printer to the lower-level sub printer (the sub printer 2 in FIG. 6). When there is no lower-level sub printer, the sub printer transmits a “Monitor status response” command to the upper-level printer. In the present embodiment, as shown in FIG. 12, the upper-level printer merges the response information from the lower-level printers, and transmits the merged information to the upper-level printer (the main printer as the highest-order printer transmits the information to the print server).

As shown in FIG. 12, the upper-level printer generates page information including the number of printed pages obtained by adding the number of printed pages by all the lower-level printers which have responded and the number of printed pages by the upper-level printer, the number of printers, which is the total number of all the lower-level printers which have responded and the main printer, and the printer information (IP address of each of the lower-level printers which have responded and the main printer, JOB ID, and the number of printed pages) as a part of the response information, for each JOB ID.

Further, in the present embodiment, the main printer also generates the failure information as a part of the response information. The failure refers to a state in which a print-disabled state (paper out, paper jam, toner out, or other failures) requiring an operator's operation occurs in the printer. As shown in FIG. 12, the main printer generates failure information including an error code relating to a failure content, the number of failed printers, printer information (IP address of each of the lower-level printers that have notified an error and the upper-level printer having an error, error code, and failed JOB ID) as a part of the response information, for each failed JOB ID. FIG. 12 depicts a case that there is no failure information in the lower-level printer.

As described above, main printer waits for the response from the sub printer to merge the response information, and transmits a “Monitor status response” command to the print server 11. If any print-disabled state (paper out, paper jam, toner out, or other failures) requiring an operator's operation does not occur in the main printer, the printing process is complete.

On the other hand, the print server 11 having received the “Monitor status response” from the main printer receives the response information as a printing result in which the pieces of information of all the printers are merged. The Monitor status response includes the printing status, and therefore the print server 11 can detect the number of printed pages and completion of printing. In this case, because printing is performed only by the main printer, only the number of printed pages by the main printer is returned back to the print server 11. The print server 11 manages the response information as the printing result in which the pieces of response information of all the printers are merged as a log.

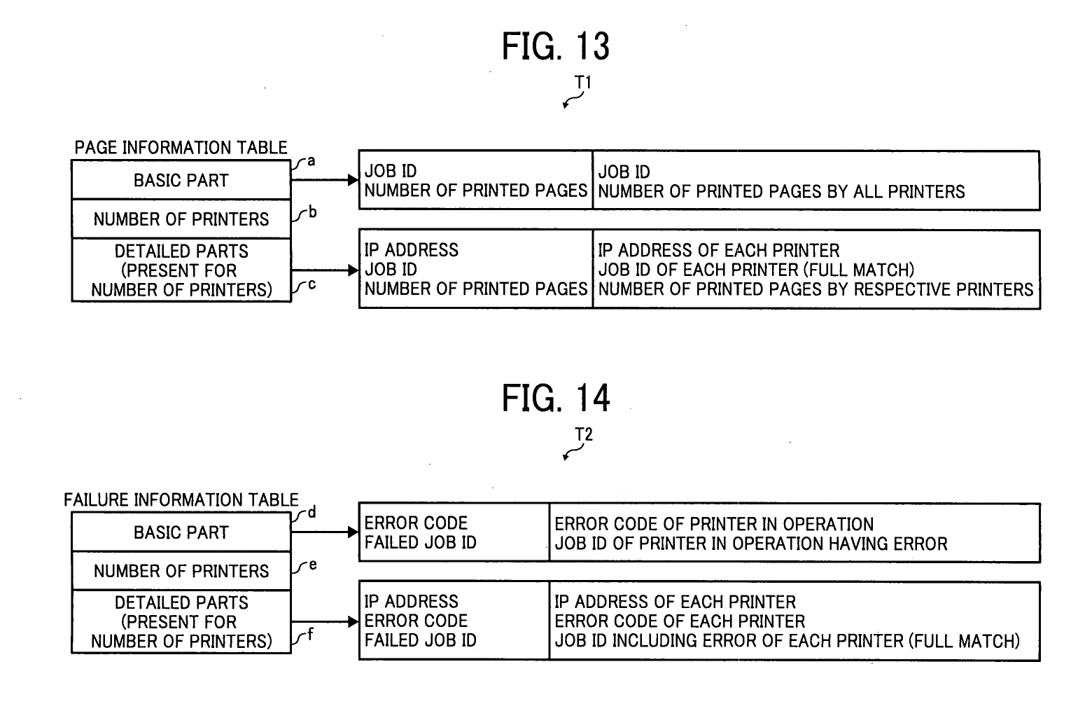

FIG. 13 is a schematic diagram of a page information table T1. As shown in FIG. 13, page information, which is a part of the response information transmitted from the main printer in the Intranet B, is stored in the page information table T1 formed in the RAM 43 of the print server 11. The page information table T1 includes a basic part a, the number of printers b, which is the total number of printers which have responded, and a detailed part c. The JOB ID and the number of printed pages by all the printers are stored in the basic part a as a log. The IP address of each printer, the JOB ID of each printer (full match), and the number of printed pages by each printer are stored in the detailed part c as a log.

FIG. 14 is a schematic diagram of a failure information table T2. As shown in FIG. 14, failure information, which is a part of the response information transmitted from the main printer in the Intranet B, is stored in the failure information table T2 formed in the RAM 43 of the print server 11. The failure information table T2 includes a basic part d, the number of printers e, which is the total number of printers having a failure, and a detailed part f. The error code relating to the failure content and the JOB ID having the failure are stored in the basic part d as a log. The IP address of each printer having the failure, the error code of each printer having the failure, and the JOB ID of each printer (full match) having the failure are stored in the detailed part f as a log.

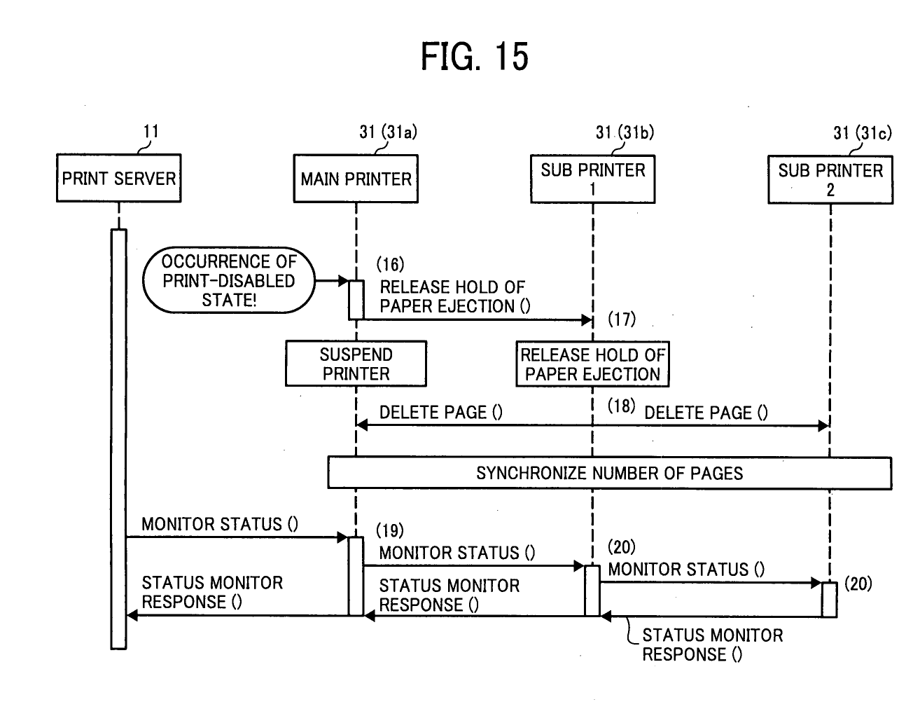

An alternative printing function when a print-disabled state (paper out, paper jam, toner out, or other failures) requiring an operator's operation occurs in the printer during the printing process is explained next. The alternative printing-function performs printing with a printer group formed by chaining plural printers via the LAN. The connection method of the printers is not limited to the chain type, and various connection methods such as a star type, a bus type, and a ring type can be also employed. FIG. 15 is a sequence diagram of a printing process procedure when the print-disabled state occurs during the printing process.

(16) When a print-disabled state (for example, paper out) requiring the operator's operation occurs in the main printer, the print-disable-information transmitting unit 105 in the main printer transmits a “Release hold of paper ejection” command to the sub printer (the sub printer 1 in FIG. 6). The main printer holds a paper ejection function and does not perform paper ejection thereafter.

The print-disabled state includes a case that a condition specified by the print server 11 at the time of printing does not match the function of the main printer. For example, the state includes a case such that the main printer is a monochrome printer, although the condition specified by the print server 11 at the time of printing is color print. Determination whether printing is possible is performed by comparing the condition specified by the print server 11 with the table relating to the printer information stored in each printer.

(17) The sub printer (the sub printer 1 in FIG. 6) having received the “Release hold of paper ejection” command compares the condition specified by the print server 11 with the table relating to the printer information. When determining that printing is possible, the sub printer releases the hold of the paper ejection to start continuous printing. When determining that printing is not possible because the condition specified by the print server 11 does not match the function of the printer, and when there is a lower-level sub printer (the sub printer 2 in FIG. 6), the sub printer transmits the “Release hold of paper ejection” command to the lower-level sub printer.

(18) The sub printer (the sub printer 1 in FIG. 6) transmits a “Delete page” command to the main printer every time the paper is ejected. When there is a lower-level sub printer (the sub printer 2 in FIG. 6), the sub printer transmits the “Delete page” command to the lower-level sub printer. Upon reception of the “Delete page” command, the main printer and the lower-level printer achieve synchronization of the number of printed pages and delete the printed page.

(19) Upon reception of the “Monitor status” command from the print server 11, the main printer transmits the “Monitor status” command to the sub printer (the sub printer 1 in FIG. 6).

(20) When there is a lower-level sub printer (the sub printer 2 in FIG. 6), the sub printer (the sub printer 1 in FIG. 6) transmits the “Monitor status” command received from the upper-level main printer to the lower-level sub printer (the sub printer 2 in FIG. 6). When there is no lower-level sub printer, the sub printer transmits the “Monitor status response” command to the upper-level printer. The main printer waits for the response from the sub printer, and transmits the “Monitor status response” command to the print server 11. Accordingly, the print server 11 receives the information of a printing result in which the pieces of information of all the printers are merged. The Monitor status response includes the printing status, and therefore the print server 11 can detect the number of printed pages and completion of printing. In this case, because printing is performed by the main printer and the sub printer 1, the numbers of printed pages by the main printer and the sub printer 1 are merged and returned as a response.

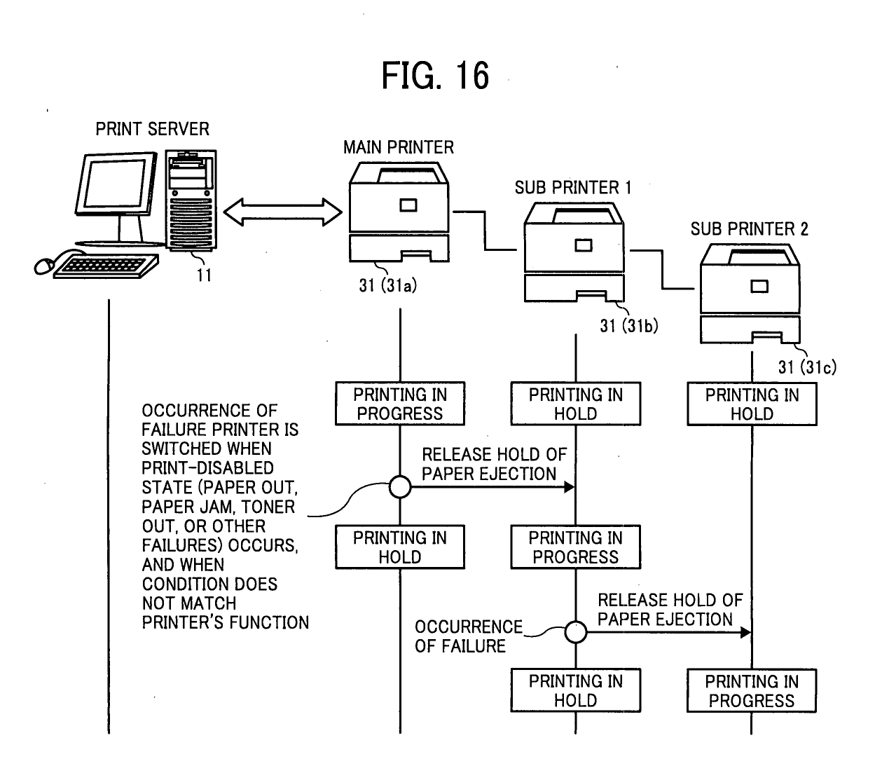

In the present embodiment, as shown in FIG. 16, when a failure in the print-disabled state (for example, paper out) requiring the operator's operation occurs in the main printer, or when a condition specified by the print server 11 does not match the function of the printer and it is determined that printing is not possible, printing is continued by the sub printer 1 without informing the print server 11 of the failure. Further, when a failure of the print-disabled state (for example, paper out) requiring the operator's operation occurs in the sub printer, or when the condition specified by the print server 11 does not match the function of the sub printer 1 and it is determined that printing is not possible, because there are two sub printers 2, printing is continued by the sub printer 2 without informing the print server 11 of the failure.

Because the main printer has a failure, the failure information is set as a part of the response information. However, because the sub printer 1 is in operation, the failure information as the printer is not set, and the failure information of the main printer is set as a breakdown. This is because the print destination is regarded as a printer “group” according to the alternative printing function.

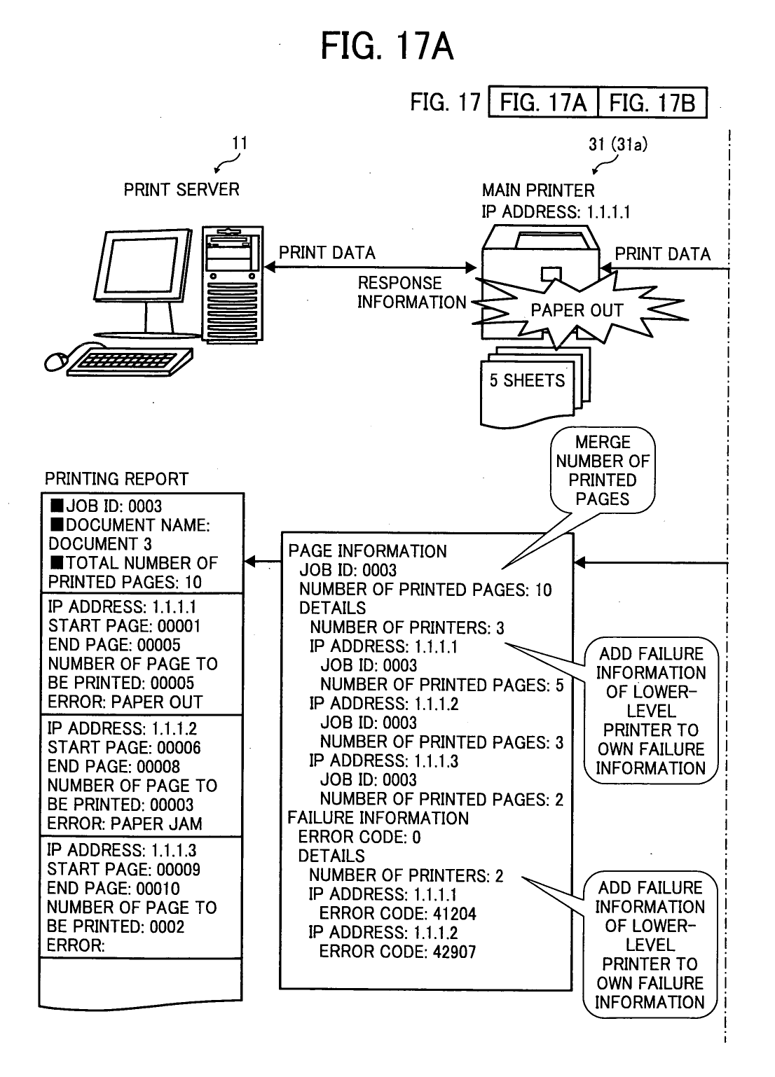

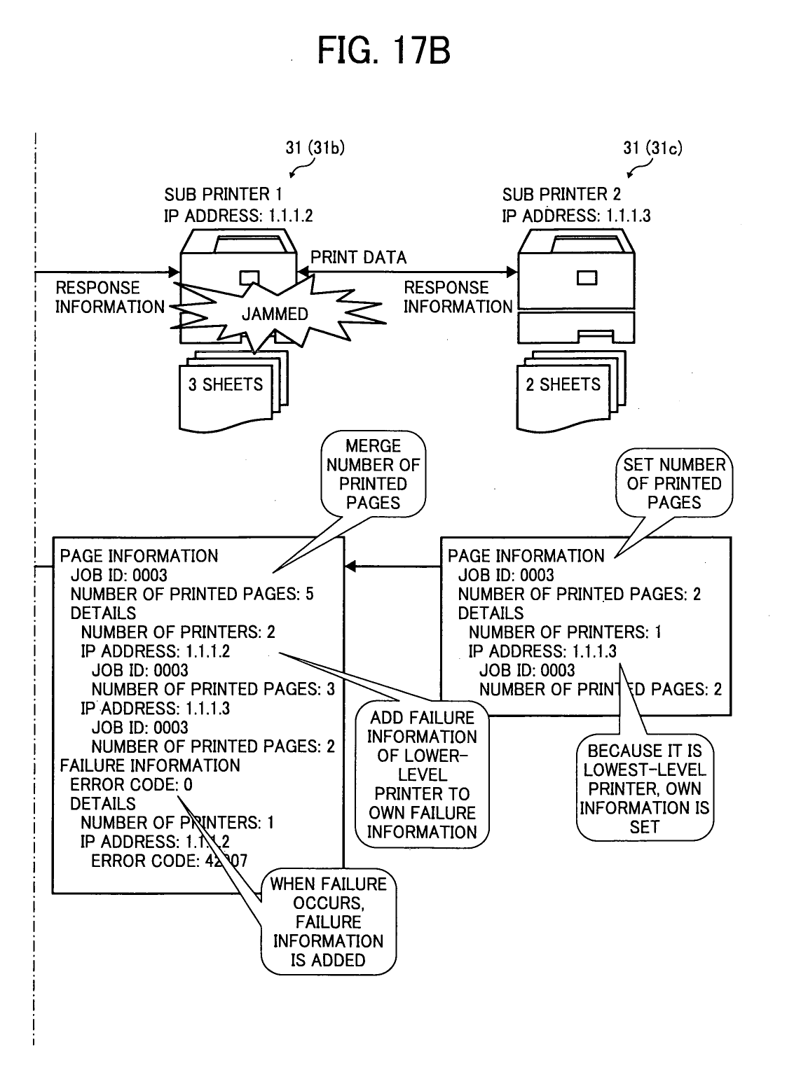

FIG. 17 is one example of alternative printing. FIG. 17 depicts a case of using 10 pieces of print data, in which after paper out occurs after five sheets are printed by the main printer, the printing process is shifted to the sub printer 1, and the paper jam occurs after three sheets are printed by the sub printer 1. Thereafter, the printing process is shifted to the sub printer 2, and two sheets are printed by the sub printer 2. As shown in FIG. 17, when a failure occurs, the failure information is added as a part of the response information.

On the other hand, the print server 11 having received the “Monitor status response” command from the main printer receives the response information of the printing result in which the pieces of information of all the printers are merged. The Monitor status response includes the printing status, and the print server 11 can detect the number of printed pages and completion of printing. In this case, because printing is performed by the main printer, the sub printer 1, and the sub printer 2, the total number of printed pages by the main printer, the sub printer 1, and the sub printer 2 is returned to the print server 11 as a response. As shown in FIGS. 13 and 14, the print server 11 manages the response information of the printing result obtained by merging all pieces of response information of all the printers as a log.

Upon completion of the printing process in the network printing process, an apparatus releasing process as shown in FIG. 6 is performed.

(5) Upon reception of a “Finish JOB” command from the print server 11, the main printer performs a JOB finishing process and transmits the “Finish JOB” command to the sub printer (the sub printer 1 in FIG. 6).

(6) The sub printer (the sub printer 1) in FIG. 6 having received the “Finish JOB” command from the main printer performs the JOB finishing process. When there is a lower-level sub printer (the sub printer 2 in FIG. 6), the sub printer (the sub printer 1 in FIG. 6) transmits the “Finish JOB” command received from the upper-level main printer to the lower-level sub printer (the sub printer 2 in FIG. 6). When there is no lower-level sub printer, the sub printer transmits a “Finish JOB response” command to the upper-level printer. The main printer waits for the response from the sub printer, and transmits the “Finish JOB response” command to the print server 11.

(7) Upon reception of a “Disengage apparatus” command from the print server 11, the main printer performs a disengaging process of the printer, and transmits the “Disengage apparatus” command to the sub printer (the sub printer 1 in FIG. 6).

(8) The sub printer (the sub printer 1 in FIG. 6) having received the “Disengage apparatus” command from the main printer performs the disengaging process of the printer. When there is a lower-level sub printer (the sub printer 2 in FIG. 6), the sub printer (the sub printer 1 in FIG. 6) transmits the “Disengage apparatus” command received from the upper-level main printer to the lower-level sub printer (the sub printer 2 in FIG. 6). When there is no lower-level sub printer, the sub printer transmits an “Apparatus disengage response” command to the upper-level printer. The main printer waits for the response from the sub printer, and transmits the “Apparatus disengage response” command to the print server 11.

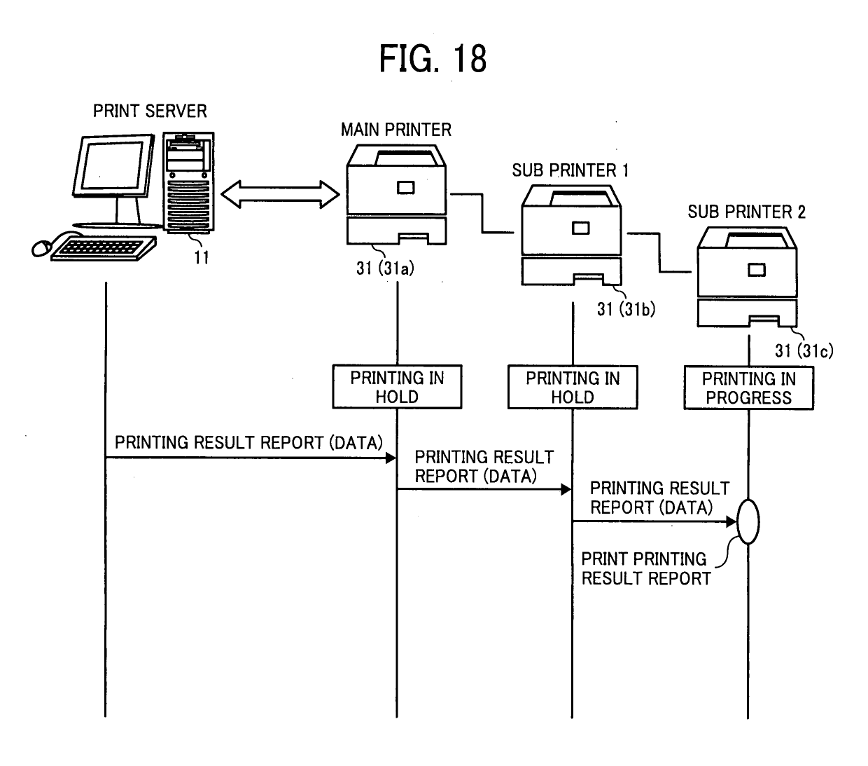

The printing process of a printing result report is explained next. As shown in FIG. 18, the print server 11 generates an output data of the printing result report based on the printer information managed by the print server 11 as a log and the information of the printing result (see FIGS. 13 and 14) in which the pieces of information of all the printers are merged, and transmits the output data to the main printer. A function of a report generating unit and a function of a report transmitting unit are executed here.

The printing result report is printed by the printer having performed the printing process lastly according to the printing process.

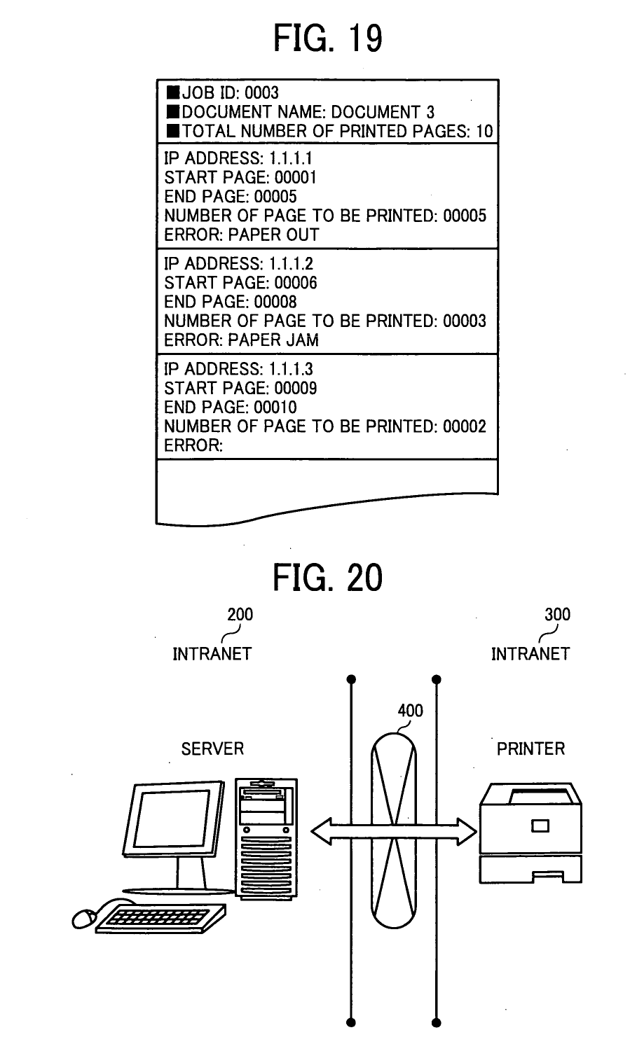

FIG. 19 is one example of the printing result report. The printer information (IP address), the start page, the last page, and the number of pages printed are printed for each printer in the printing result report shown in FIG. 19, together with the JOB ID, a document name, and the total number of printed pages. For the printer having a failure, the content thereof is also printed. Because both of a transmission side and a reception side confirm the printing result report, alternative printing can be confirmed, and due to an alternatively printed history of the printer, forgetting to pick up a printed sheet or picking up a wrong sheet can be prevented.

As described above, according to the present embodiment, even if a print-disabled state (paper out, paper jam, toner out, or other failures) requiring the operator's operation occurs in the printer in the printing operation, an alternative printer takes over the printing job continuously. Therefore, the printing is not held even if the failure occurs, and printing can be reliably performed, thereby enabling to increase printing reliability. Further, even if the printer does not match with the condition specified by the print server and it is determined that printing is not possible, an alternative printer matching with the condition specified by the print server takes over the printing job continuously, thereby enabling to perform printing reliably and increase the printing reliability.

The information of the lower-level printer and the information of the high-order printer are merged and returned to the upper-level printer (or a host apparatus), thereby enabling to check various pieces of information reliably by the host apparatus. For example, by merging the pieces of information including the printing status (output destination, the number of output pages, and the like) of respective printing apparatuses and responding to the upper-level printer (or the print server), the transmission side (the print server) can check the printing result by each printing apparatus reliably.

Because the report is printed based on the information including the printing status (the output destination, the number of output pages, and the like) of the respective printing apparatus obtained by the host apparatus, consolidated data can be printed as the printing result report. Accordingly, because both of the transmission side and the reception side confirm the printing result report, alternative printing can be confirmed, and due to an alternatively printed history of the printer, forgetting to pick up a printed sheet or picking up a wrong sheet can be prevented.

Because the printer group connected via the network includes plural printers having the same function, even if the printer is switched, the same printing result can be obtained.

With regard to the print server, suspension of printing due to a failure can be prevented by incorporating the alternative printing function on the printer. Accordingly, it is possible to reduce the number of development steps of recovery processing at the time of a failure in the printer.

With regard to the printer, by configuring the main printer and the sub printer with a common application, the printer can be provided at a reasonable price.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printing apparatus comprising:
a connecting unit that makes a network connection to other printing apparatus that performs a printing process of printing data transmitted from a host apparatus on a printing medium on a downstream side in a data transmission direction;
a first transmitting unit that transmits print hold information for holding the printing process to the other printing apparatus;
a second transmitting unit that transmits the printing data to the other printing apparatus;
a third transmitting unit that transmits page deletion information for deleting data corresponding to a printed page to the other printing apparatus every time a page is printed on the printing medium; and
a fourth transmitting unit that transmits, when a function of the printing apparatus cannot satisfy a condition specified by the host apparatus at a time of printing, print-disable information to the other printing apparatus, and releases a hold of the printing process in the other printing apparatus according to the print-disable information.

2. The printing apparatus according to claim 1, wherein the fourth transmitting unit further transmits the print-disable information to the other printing apparatus when a failure occurs causing a print-disabled state requiring an operator's operation.

3. The printing apparatus according to claim 1, further comprising a storage unit that stores therein a function that can be specified at the time of printing, wherein
when the function stored in the storage unit cannot satisfy the condition specified by the host apparatus at the time of printing, the fourth transmitting unit transmits the print-disable information to the other printing apparatus.

4. The printing apparatus according to claim 3, further comprising an update unit that updates the function stored in the storage unit.

5. The printing apparatus according to claim 4, wherein the update unit updates the function stored in the storage unit when the connecting unit connects the printing apparatus to the other printing apparatus.

6. A printing control method for a printing apparatus that performs a printing process of printing data transmitted from a host apparatus on a printing medium, the printing control method comprising:
making a network connection to other printing apparatus on a downstream side in a data transmission direction;
first transmitting including transmitting print hold information for holding the printing process to the other printing apparatus;
second transmitting including transmitting the printing data to the other printing apparatus;
third transmitting including transmitting page deletion information for deleting data corresponding to a printed page to the other printing apparatus every time a page is printed on the printing medium; and
fourth transmitting including
transmitting, when a function of the printing apparatus cannot satisfy a condition specified by the host apparatus at a time of printing, print-disable information to the other printing apparatus, and
releasing a hold of the printing process in the other printing apparatus according to the print-disable information.

7. The printing control method according to claim 6, wherein the fourth transmitting further includes transmitting the print-disable information to the other printing apparatus when a failure occurs causing a print-disabled state requiring an operator's operation.

8. The printing control method according to claim 6, further comprising storing a function that can be specified at the time of printing, wherein
when the function stored at the storing cannot satisfy the condition specified by the host apparatus at the time of printing, the fourth transmitting further includes transmitting the print-disable information to the other printing apparatus.
